(19) United States
(12) Patent Application Publication
(10) Pub. No.: US 2024/0319890 A1
(43) Pub. Date: Sep. 26, 2024

(54) ELECTRONIC DEVICE INCLUDING A PLURALITY OF STORAGE DEVICES AND OPERATING METHOD OF ELECTRONIC DEVICE

(71) Applicant: Samsung Electronics Co., Ltd., Suwon-si, Gyeonggi-do (KR)

(72) Inventors: Jaigyun LIM, Suwon-si (KR); Jin-Hee MA, Suwon-si (KR); Kyuho SON, Suwon-si (KR); Sangyoon OH, Suwon-si (KR); Wonchul LEE, Suwon-si (KR)

(73) Assignee: Samsung Electronics Co., Ltd., Suwon-si, Gyeonggi-do (KR)

(21) Appl. No.: 18/467,338

(22) Filed: Sep. 14, 2023

(30) Foreign Application Priority Data
Mar. 22, 2023 (KR) 10-2023-0037421

(51) Int. Cl. G06F 3/06

(52) U.S. Cl. CPC G06F 3/0619; G06F 3/0659; G06F 3/0689

(57) ABSTRACT

Disclosed is a storage system which includes a random access memory, storage devices, and a processing unit that controls the random access memory and the storage devices. Each of the plurality of storage devices includes a first storage area and a second storage area. The processing unit assigns a zone to the first storage areas of the storage devices. The processing unit assigns RAID stripes to the zone, performs a write of sequential data, which are based on sequential logical addresses, with respect to each of the RAID stripes, and performs a write of a parity corresponding to the write of the sequential data after the write of the sequential data is completed. The processing unit writes an intermediate parity corresponding to the parity in the second storage area of at least one storage device among the storage devices while performing the write of the sequential data.

### CROSS-REFERENCE TO RELATED APPLICATIONS

This application claims priority under 35 U.S.C. § 119 to Korean Patent Application No. 10-2023-0037421 filed on Mar. 22, 2023, in the Korean Intellectual Property Office, the disclosures of which are incorporated by reference herein in their entireties.

### BACKGROUND

Embodiments of the present disclosure described herein relate to an electronic device including a plurality of storage devices, and more particularly, relate to an electronic device with an improved speed and improved reliability and an operating method of the electronic device.

A storage device refers to a device which stores data under control of a host device (such as a computer, a smartphone, a smart pad, and/or the like). The storage device includes a device configured to store data on a magnetic disk (such as a hard disk drive (HDD)), and/or a device configured to store data in a semiconductor memory (e.g., a nonvolatile memory, such as a solid state drive (SSD) or a memory card).

The nonvolatile memory includes a read only memory (ROM), a programmable ROM (PROM), an electrically programmable ROM (EPROM), an electrically erasable and programmable ROM (EEPROM), a flash memory, a phase-change random access memory (PRAM), a magnetic RAM (MRAM), a resistive RAM (RRAM), a ferroelectric RAM (FRAM), and/or the like.

The lifetime and reliability of the nonvolatile memory may be reduced whenever a write operation is performed in the nonvolatile memory. In particular, the flash memory (e.g., a NAND flash memory) has a write-before-erase characteristic that an erase operation should be performed between the write operations. Because the write operation of the flash memory causes the erase operation, the repetitive write operations of the flash memory may reduce the lifetime and reliability of the flash memory.

### SUMMARY

Embodiments of the present disclosure provide an electronic device that includes a plurality of storage devices, provides a reduced write amplification factor (WAF) with respect to the plurality of storage devices, and has an improved speed and improved reliability and an operating method of the electronic device.

According to at least one embodiment, a storage system includes a random access memory; a plurality of storage devices; and processing circuitry configured to control the random access memory and the plurality of storage devices, wherein each of the plurality of storage devices includes a first storage area and a second storage area, wherein the processing circuitry is configured to assign a zone to the first storage areas of the plurality of storage devices, assign a plurality of Redundant Array of Inexpensive Disks (RAID) stripes to the zone, write sequential data with respect to each of the plurality of RAID stripes, the sequential data based on sequential logical addresses, write of a parity corresponding to the write of the sequential data after the write of the sequential data is completed, and wherein the processing circuitry is further configured to write an intermediate parity, corresponding to the parity, in the second storage area of at least one storage device, among the plurality of storage devices while performing the write of the sequential data.

According to at least one embodiment, an operating method of a storage system including a plurality of storage devices each including a first storage area and a second storage area includes writing first data in the first storage area of a first storage device of the plurality of storage devices; generating a first intermediate parity from the first data; writing the first intermediate parity in the second storage area of a fourth storage device of the plurality of storage devices; writing second data in the first storage area of a second storage device of the plurality of storage devices; generating a second intermediate parity from the first intermediate parity and the second data; and writing the second intermediate parity in the second storage area of the fourth storage device.

According to at least one embodiment, a storage system includes a processing circuitry configured to control the random access memory and the plurality of storage devices, wherein each of the plurality of storage devices includes a first storage area and a second storage area, wherein the processing circuitry is configured to assign a zone to the first storage areas of the plurality of storage devices, write first data in the first storage area of a first storage device of the plurality of storage devices, generate a first intermediate parity from the first data, write the first intermediate parity in the random access memory and the second storage area of a fourth storage device of the plurality of storage devices, write second data in the first storage area of a second storage device of the plurality of storage devices, generate a second intermediate parity from the first intermediate parity and the second data, write the second intermediate parity in the random access memory and the second storage area of the fourth storage device, write third data in the first storage area of a third storage device, generate a parity from the second intermediate parity and the third data, and write the parity in the first storage area of the fourth storage device.

### BRIEF DESCRIPTION OF THE FIGURES

The above and other objects and features of the present disclosure will become apparent by describing in detail embodiments thereof with reference to the accompanying drawings.

FIG. 1 illustrates an electronic device according to at least one embodiment of the present disclosure.

FIG. 2 illustrates a storage device according to at least one embodiment of the present disclosure.

FIG. 3 is a block diagram illustrating a nonvolatile memory device according to at least one embodiment of the present disclosure.

FIG. 4 illustrates an example in which an electronic device initializes storage devices.

FIG. 5 illustrating an example in which RAID stripes are defined in storage devices and logical addresses are assigned thereto.

FIG. 6 illustrates an example in which an electronic device opens a zone in a plurality of storage devices.

FIG. 7 illustrates an example in which a first zone and a second zone are generated in storage devices.

FIG. 8 illustrates an example in which a third zone is generated in storage devices.

FIG. 9 is a diagram illustrating an example where an electronic device according to at least one embodiment of the present disclosure writes data in storage devices.

FIGS. 10, 11, and 12 illustrate examples in which data are written in storage devices depending on the method of FIG. 9.

FIG. 13 illustrates an example in which an electronic device recovers an intermediate RAID parity when a power is turned on after a power-off event.

FIG. 14 illustrates another example in which an electronic device recovers an intermediate RAID parity when a power is turned on after a power-off event.

FIG. 15 illustrating an example in which an electronic device recovers data by using an intermediate RAID parity or a RAID parity.

FIG. 16 is a diagram illustrating a system according to at least one embodiment of the present disclosure.

### DETAILED DESCRIPTION

Below, embodiments of the present disclosure will be described in detail with reference to the attached drawings to such an extent that the embodiments of the present disclosure are easily implemented by one skilled in the art to which the present disclosure belongs.

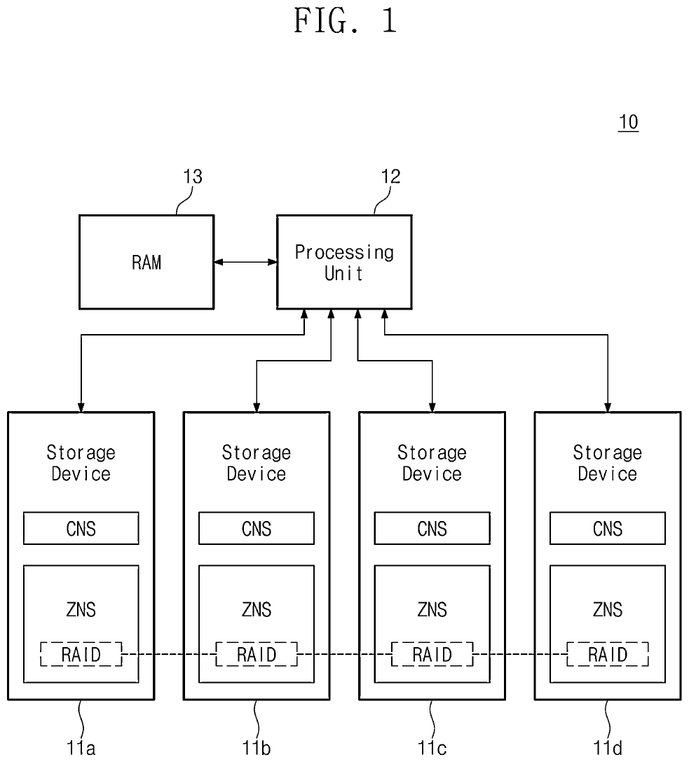

FIG. 1 illustrates an electronic device 10 according to at least one embodiment of the present disclosure. Referring to FIG. 1, the electronic device 10 includes a plurality of storage devices 11a, 11b, 11c, and 11d, a processing unit 12, and a random access memory (RAM) 13.

Each of the plurality of storage devices 11a, 11b, 11c, and 11d may include a nonvolatile memory device configured to retain data stored therein even when a power is turned off. For example, each of the plurality of storage devices 11a, 11b, 11c, and 11d may be (or include) a solid state drive. Though the electronic device 10 is illustrated as including four (4) storage devices, the plurality of storage devices is not limited thereto, and may include, e.g., more storage devices than illustrated. Each of the plurality of storage devices 11a, 11b, 11c, and 11d may include a first storage area ZNS and a second storage area CNS.

The first storage area ZNS may be used as a zoned namespace. Each of the plurality of storage devices 11a, 11b, 11c, and 11d may be configured to permit sequential writes (or only sequential writes), which are based on sequential logical addresses, in the first storage area ZNS. A portion of the first storage area ZNS, for example, a portion of a storage space may be used to implement Redundant Array of Inexpensive Disks (RAID). For example, the storage space may be used based on a RAID (e.g., RAID5 and/or RAID 4) standard.

The second storage area CNS may be a conventional namespace. Each of the plurality of storage devices 11a, 11b, 11c, and 11d may permit writes, which are based on a random logical address(es), in the second storage area CNS. The storage capacity of the second storage area CNS may be smaller than the storage capacity of the first storage area ZNS. The write speed of the second storage area CNS may be faster than the write speed of the first storage area ZNS, and the read speed of the second storage area CNS may be faster than the read speed of the first storage area ZNS.

The processing unit 12 may include processing circuitry, such as hardware, software, or a combination thereof configured to perform a specific function. For example, in at least one embodiment, the processing circuitry may include a central processing unit (CPU), an application processor (AP), and/or the like. The processing unit 12 may be configured to execute an operating system to drive the electronic device 10. The processing unit 12 may be configured to execute various applications. The random access memory 13 may be configured to be used for various purposes such as a system memory of the electronic device 10, a working memory of the processing unit 12, a buffer memory of the processing unit 12, a cache memory of the processing unit 12, and/or the like.

The processing unit 12 is configured to control (and/or perform) the sequential writes on the first storage area ZNS, based on sequential logical addresses. For example, continuous writes that the processing unit 12 performs on the first storage area ZNS may be based on continuous logical addresses.

The processing unit 12 may be further configured to control (and/or perform) random writes on the second storage area CNS, based on random logical addresses. For example, logical addresses of continuous writes that the processing unit 12 performs on the second storage area CNS may be independent of each other.

In at least one embodiment, the electronic device 10 may be a storage server that writes and/or reads data in response to a request of an external host and/or an application server.

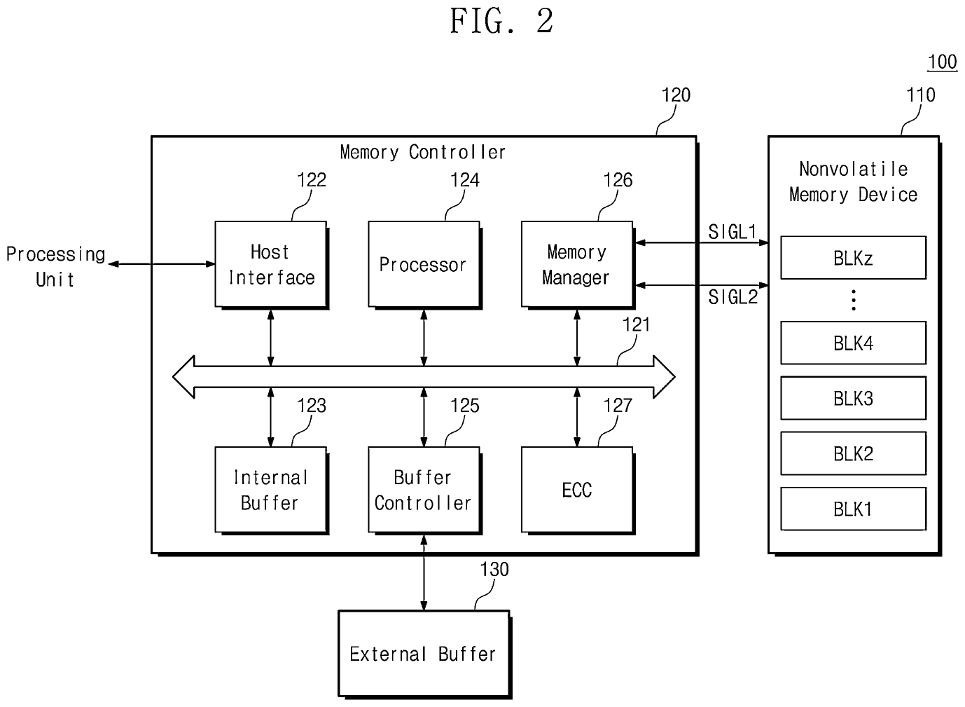

FIG. 2 illustrates a storage device 100 according to at least one embodiment of the present disclosure. Referring to FIG. 2, the storage device 100 may correspond to one (or each) of the plurality of storage devices 11a, 11b, 11c, and 11d of FIG. 1. The storage device 100 may include a nonvolatile memory device 110, a memory controller 120, and an external buffer 130. The nonvolatile memory device 110 may include a plurality of memory cells. In at least one embodiment, each of the plurality of memory cells may be configured to store two or more bits.

In at least one embodiment, the nonvolatile memory device 110 includes at least one of various nonvolatile memory devices such as a flash memory device, a phase-change memory device, a ferroelectric memory device, a magnetic memory device, a resistive memory device, and/or the like.

The memory controller 120 may receive various requests for writing data in the nonvolatile memory device 110 and/or reading data from the nonvolatile memory device 110, from the processing unit 12 (e.g., from an external host device). The memory controller 120 may be configured to store (or buffer) user data communicated with the processing unit 12 in the external buffer 130 and may store metadata for managing the storage device 100 in the external buffer 130.

In at least one embodiment, the memory controller 120 is configured to access the nonvolatile memory device 110 through first signal lines SIGL1 and second signal lines SIGL2. For example, the memory controller 120 may transmit a command and an address to the nonvolatile memory device 110 through the first signal lines SIGL1. The memory controller 120 may exchange data with the nonvolatile memory device 110 through the first signal lines SIGL1.

The memory controller 120 may be configured to transmit a first control signal to the nonvolatile memory device 110 through the second signal lines SIGL2. The memory controller 120 may receive a second control signal from the nonvolatile memory device 110 through the second signal lines SIGL2.

In at least one embodiment, the memory controller 120 is configured to control two or more nonvolatile memory devices. For example, the memory controller 120 may be connected with first signal lines and second signal lines provided for each of the two or more nonvolatile memory devices.

As another example, the memory controller 120 may be connected with first signal lines shared by the two or more nonvolatile memory devices. The memory controller 120 may be connected with some of the second signal lines shared by the two or more nonvolatile memory devices and may be connected with the others thereof provided for each of the two or more nonvolatile memory devices.

In at least one embodiment, the external buffer 130 may include a random access memory. For example, the external buffer 130 may include at least one of a dynamic random access memory, a phase change random access memory, a ferroelectric random access memory, a magnetic random access memory, and a resistive random access memory.

The nonvolatile memory device 110 may include a plurality of memory blocks BLK1 to BLKz. In at least one embodiment, each of the plurality of memory blocks BLK1 to BLKz may be a unit of an erase operation. Memory cells belonging to each memory block may be erased at the same time. As another example, each of the memory blocks BLK1 to BLKz may be divided into a plurality of sub-blocks. Each of the plurality of sub-blocks may correspond to a unit of the erase operation. As another example, two or more memory blocks may constitute one super block. Each super block may correspond to a unit of the erase operation. The unit of the erase operation is referred to as an “erase unit”. That is, the erase unit may be a memory block, a sub-block of a memory block, a super block of memory blocks, and/or a combination thereof.

The memory controller 120 may include a bus 121, a host interface 122, an internal buffer 123, a processor 124, a buffer controller 125, a memory manager 126, and an error correction code (ECC) block 127.

The bus 121 is configured to provide communication channels between the components of the memory controller 120. The host interface 122 is configured to receive various requests from the external host device and may parse the received requests. The host interface 122 may store the parsed requests in the internal buffer 123.

The host interface 122 may transmit various responses to the external host device. The host interface 122 may exchange signals with the external host device in compliance with a given communication protocol. The internal buffer 123 may include a random access memory. For example, the internal buffer 123 may include a static random access memory (SRAM), a dynamic random access memory (DRAM), and/or the like.

The processor 124 is configured to execute an operating system or firmware for driving the memory controller 120. For example, the processor 124 may read the parsed requests stored in the internal buffer 123 and may generate addresses and commands for controlling the nonvolatile memory device 110. The processor 124 may provide the generated commands and addresses to the memory manager 126.

The processor 124 may store various metadata for managing the storage device 100 in the internal buffer 123. The processor 124 may access the external buffer 130 through the buffer controller 125. The processor 124 may control the buffer controller 125 and the memory manager 126 such that the user data stored in the external buffer 130 are transferred to the nonvolatile memory device 110.

The processor 124 may control the host interface 122 and the buffer controller 125 such that the data stored in the external buffer 130 are transferred to the external host device. The processor 124 may control the buffer controller 125 and the memory manager 126 such that the data received from the nonvolatile memory device 110 are stored in the external buffer 130. The processor 124 may control the host interface 122 and the buffer controller 125 such that the data received from the external host device are stored in the external buffer 130.

The buffer controller 125, under the control of the processor 124, is configured to write data in the external buffer 130 and/or may read data from the external buffer 130. The memory manager 126 may communicate with the nonvolatile memory device 110 through the first signal lines SIGL1 and the second signal lines SIGL2 under control of the processor 124.

The memory manager 126 is configured to access the nonvolatile memory device 110 under the control of the processor 124. For example, the memory manager 126 may access the nonvolatile memory device 110 through the first signal lines SIGL1 and the second signal lines SIGL2. The memory manager 126 may communicate with the nonvolatile memory device 110, based on a protocol that is defined to be compliance with a standard and/or by a manufacturer.

The error correction code (ECC) block 127 is configured to perform error correction encoding on data to be provided to the nonvolatile memory device 110 by using the error correction code ECC. For example, the error correction code block 127 may perform error correction decoding on data received from the nonvolatile memory device 110 by using the error correction code ECC.

The memory controller 120 may assign the first storage area ZNS and the second storage area CNS to units of memory block. For example, the memory controller 120 may assign at least two memory blocks, among the plurality of memory blocks BLK1 to BLKz, to the first storage area ZNS and may assign at least one memory block, among the plurality of memory blocks BLK1 to BLKz, to the second storage area CNS.

As another example, the memory controller 120 may assign the first storage area ZNS and the second storage area CNS in units of an erase unit. For example, the memory controller 120 may assign at least two erase units, among a plurality of erase units, to the first storage area ZNS and may assign at least one erase unit among the plurality of erase units to the second storage area CNS.

In at least one embodiment, the memory controller 120 may use at least one memory block or at least one erase unit as a meta storage area. The memory controller 120 may store original data of a map table storing mapping information between logical addresses of the processing unit 12 and physical addresses of the nonvolatile memory device 110 in the meta storage area. Alternatively, the memory controller 120 may store original data of various metadata for managing the storage device 100 in the meta storage area. The memory controller 120 may load and use the map table and/or the metadata of the meta storage area to the internal buffer 123 or the external buffer 130.

In at least one embodiment, the external buffer 130 and the buffer controller 125 may be omitted in the storage device 100. When the external buffer 130 and the buffer controller 125 are omitted, the functions that are described as being performed by the external buffer 130 and the buffer controller 125 may be performed by the internal buffer 123.

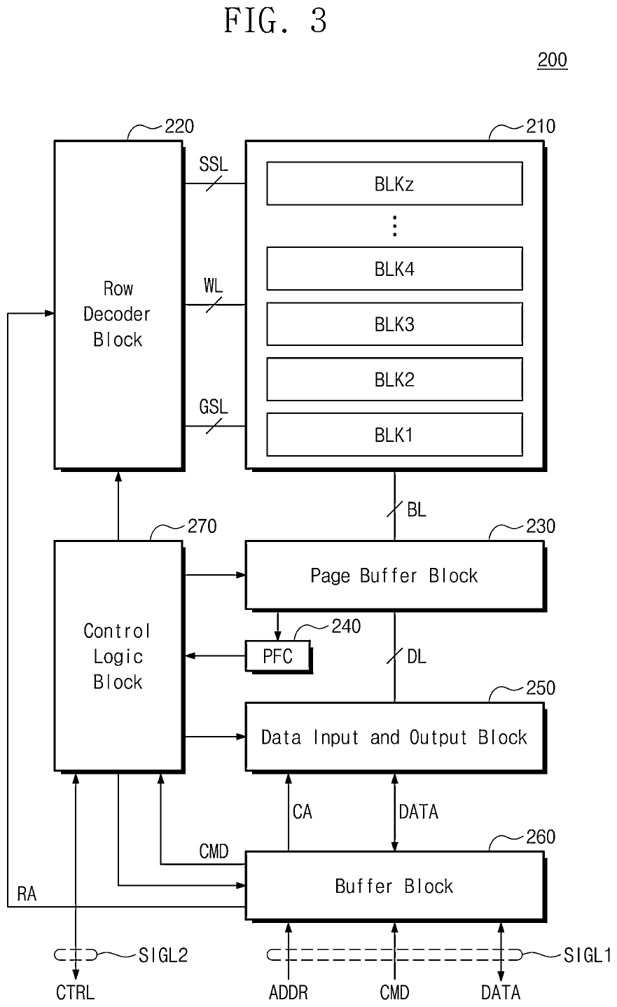

FIG. 3 is a block diagram illustrating a nonvolatile memory device 200 according to at least one embodiment of the present disclosure. Referring to FIGS. 2 and 3, the nonvolatile memory device 200 may correspond to the nonvolatile memory device 110 of FIG. 2. The nonvolatile memory device 200 may include a memory cell array 210, a row decoder block 220, a page buffer block 230, a pass/fail check block (PFC) 240, a data input and output block 250, a buffer block 260, and a control logic block 270.

The memory cell array 210 includes the plurality of memory blocks BLK1 to BLKz. Each of the memory blocks BLK1 to BLKz includes a plurality of memory cells. Each of the memory blocks BLK1 to BLKz may be connected to the row decoder block 220 through at least one ground selection line GSL, word lines WL, and at least one string selection line SSL. Some of the word lines WL may be used as dummy word lines. Each of the memory blocks BLK1 to BLKz may be connected to the page buffer block 230 through a plurality of bit lines BL. The plurality of memory blocks BLK1 to BLKz may be connected in common to the plurality of bit lines BL.

In at least one embodiment, each of the plurality of memory blocks BLK1 to BLKz may be a unit of the erase operation. Memory cells belonging to each memory block may be erased at the same time. As another example, each of the memory blocks BLK1 to BLKz may be divided into a plurality of sub-blocks. Each of the plurality of sub-blocks may correspond to a unit of the erase operation. As another example, two or more memory blocks may constitute one super block. Each super block may correspond to a unit of the erase operation. The unit of the erase operation is referred to as an “erase unit”. That is, the erase unit may be a memory block, a sub-block of a memory block, a super block of memory blocks, and/or a combination thereof.

The row decoder block 220 is connected to the memory cell array 210 through the ground selection lines GSL, the word lines WL, and the string selection lines SSL. The row decoder block 220 operates under control of the control logic block 270.

The row decoder block 220 is configured to decode a row address RA received from the buffer block 260 and to control voltages to be applied to the string selection lines SSL, the word lines WL, and the ground selection lines GSL based on the decoded row address.

The page buffer block 230 is connected to the memory cell array 210 through the plurality of bit lines BL. The page buffer block 230 is connected to the data input and output block 250 through a plurality of data lines DL. The page buffer block 230 operates under control of the control logic block 270.

In a program operation, the page buffer block 230 is configured to store data to be written in memory cells. The page buffer block 230 may apply voltages to the plurality of bit lines BL based on the stored data. In a read operation or in a verify read operation that is performed in the program operation or the erase operation, the page buffer block 230 may sense voltages of the bit lines BL and may store a sensing result.

In the verify read operation associated with the program operation or the erase operation, the pass/fail check (PFC) block 240 may verify the sensing result of the page buffer block 230. For example, in the verify read operation that is performed in the program operation, the pass/fail check block 240 may count the number of values (e.g., “0”) corresponding to on-cells that are not programmed to a target threshold voltage or higher.

In the verify read operation that is performed in the erase operation, the pass/fail check block 240 may count the number of values (e.g., “1”) corresponding to off-cells that are not erased to a target threshold voltage or lower. When the counting result is greater than or equal to a threshold value, the pass/fail check block 240 may output a fail signal to the control logic block 270. When the counting result is smaller than the threshold value, the pass/fail check block 240 may output a pass signal to the control logic block 270. Depending on a verification result of the pass/fail check block 240, a program loop of the program operation may be further performed, or an erase loop of the erase operation may be further performed.

The data input and output block 250 is connected to the page buffer block 230 through the plurality of data lines DL. The data input and output block 250 may receive a column address CA from the buffer block 260. The data input and output block 250 may output the data read by the page buffer block 230 to the buffer block 260 depending on the column address CA. The data input and output block 250 may provide the data received from the buffer block 260 to the page buffer block 230, based on the column address CA.

Through the first signal lines SIGL1, the buffer block 260 may receive a command CMD and an address ADDR from an external device and may exchange data “DATA” with the external device. The buffer block 260 may operate under control of the control logic block 270. The buffer block 260 may provide the command CMD to the control logic block 270; the buffer block 260 may provide the row address RA of the address ADDR to the row decoder block 220 and may provide the column address CA of the address ADDR to the data input and output block 250; and the buffer block 260 may exchange the data “DATA” with the data input and output block 250.

The control logic block 270 is configured to exchange a control signal CTRL with the external device through the second signal lines SIGL2. The control logic block 270 may allow the buffer block 260 to route the command CMD, the address ADDR, and the data “DATA”. The control logic block 270 may decode the command CMD received from the buffer block 260 and may control the nonvolatile memory device 200 based on the decoded command.

In at least one embodiment, the nonvolatile memory device 200 may be manufactured in a bonding method. The memory cell array 210 may be manufactured by using a first wafer, and the row decoder block 220, the page buffer block 230, the pass/fail check block 240, the data input and output block 250, the buffer block 260, and the control logic block 270 may be manufactured by using a second wafer. The nonvolatile memory device 200 may be implemented by coupling the first wafer and the second wafer such that an upper surface of the first wafer and an upper surface of the second wafer face each other.

As another example, the nonvolatile memory device 200 may be manufactured in a cell over peri (COP) method. A peripheral circuit including the row decoder block 220, the page buffer block 230, the pass/fail check block 240, the data input and output block 250, the buffer block 260, and the control logic block 270 may be implemented on a substrate. The memory cell array 210 may be implemented over the peripheral circuit. The peripheral circuit and the memory cell array 210 may be connected by using through vias.

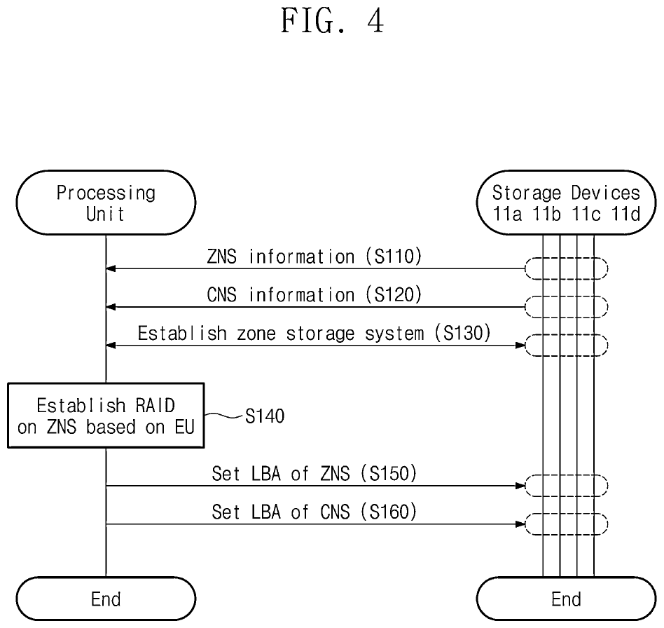

FIG. 4 illustrates an example in which the electronic device 10 initializes the storage devices 11a, 11b, 11c, and 11d. Referring to FIGS. 1 and 4, at operation S110, each of the storage devices 11a, 11b, 11c, and 11d provides information of the first storage area ZNS to the processing unit 12. For example, each of the storage devices 11a, 11b, 11c, and 11d may provide the processing unit 12 with information about a capacity of a storage space, which is permitted by the processing unit 12 so as to be used, from among storage spaces of the first storage area ZNS and with information about a capacity of each memory block and/or each erase unit of the first storage area ZNS.

At operation S120, each of the storage devices 11a, 11b, 11c, and 11d provides information of the second storage area CNS to the processing unit 12. For example, each of the storage devices 11a, 11b, 11c, and 11d may provide the processing unit 12 with information about a capacity of a storage space, which is permitted by the processing unit 12 so as to be used, from among storage spaces of the second storage area CNS and with information about a capacity of each memory block and/or each erase unit of the second storage area CNS.

At operation S130, the processing unit 12 establishes a zone storage system with the storage devices 11a, 11b, 11c, and 11d. For example, the processing unit 12 may notify the storage devices 11a, 11b, 11c, and 11d that the storage devices 11a, 11b, 11c, and 11d are included in the zone storage system.

The processing unit 12 may determine the number of zones to be assigned to the storage devices 11a, 11b, 11c, and 11d, based on a zone size and the information regarding the first storage area ZNS. The processing unit 12 may notify information about the number of zones to the storage devices 11a, 11b, 11c, and 11d. For example, the zone size may be determined by at least one of a standard, the processing unit 12, the manufacturer of the storage devices 11a, 11b, 11c, and 11d, and/or by a user input.

At operation S140, the processing unit 12 establishes the RAID in the first storage areas ZNS of the storage devices 11a, 11b, 11c, and 11d, based on an erase unit EU. For example, the processing unit 12 may integrate the storage spaces of the first storage areas ZNS of the storage devices 11a, 11b, 11c, and 11d and may partition the integrated storage space into a first area and a second area. In the first area and the second area, the processing unit 12 may define a plurality of RAID stripes.

Each of the plurality of RAID stripes may include a plurality of areas. The plurality of areas may respectively correspond to the storage devices 11a, 11b, 11c, and 11d. The plurality of areas may include two or more zone areas (e.g., included in the first area) and at least one RAID area (e.g., included in the second area). The processing unit 12 may store data in the two or more zone areas and may store a RAID parity in the at least one RAID area.

At operation S150, the processing unit 12 sets logical addresses LBA to the first storage areas ZNS of the storage devices 11a, 11b, 11c, and 11d. For example, the processing unit 12 may set continuous logical addresses LBA to at least the first area (or the first area and the second area) of the first storage areas ZNS of the storage devices 11a, 11b, 11c, and 11d and may set the continuous logical addresses LBA to each RAID stripe.

For example, in each RAID stripe, the processing unit 12 may alternately set continuous logical addresses to zone areas. For example, the processing unit 12 may assign a first logical address group, which corresponds to first logical addresses being continuous, to the storage space of the first zone area of each RAID stripe. The processing unit 12 may assign a second logical address group, which corresponds to second logical addresses following the first logical addresses and being continuous, to the storage space of the second zone area. In each RAID stripe, the processing unit 12 may assign a logical address group, which corresponds to continuous logical addresses that follow the logical addresses of the zone areas and are continuous thereto, to the RAID area.

As another example, the processing unit 12 may set continuous logical addresses to the first area. For example, the processing unit 12 may assign a first logical address group, which corresponds to first logical addresses being continuous, to the storage space of the first zone area of each RAID stripe. The processing unit 12 may assign a second logical address group, which corresponds to second logical addresses that follow the first logical addresses and are continuous thereto, to the storage space of the second zone area.

The processing unit 12 may assign logical addresses to the second area. For example, the processing unit 12 may assign a logical address group corresponding to continuous logical addresses, for each RAID area of each RAID stripe. Logical addresses of one RAID area may be continuous or discontinuous to logical addresses of any other RAID area (e.g., any other RAID stripe) or logical addresses of a zone area (e.g., the same RAID stripe).

At operation S160, the processing unit 12 sets the logical addresses LBA to the second storage area CNS of each of the storage devices 11a, 11b, 11c, and 11d. For example, the processing unit 12 may set a logical address group of continuous logical addresses LBA to the second storage area CNS of each of the storage devices 11a, 11b, 11c, and 11d. Logical addresses of the second storage area CNS of one storage device may be continuous or discontinuous to logical addresses of the second storage area CNS of another storage device. Logical addresses of the second storage area CNS of one storage device may be continuous or discontinuous to logical addresses of the first area or the second area of the first storage area ZNS.

In at least one embodiment, the method described with reference to FIG. 4 may relate to a provisioning process that the processing unit 12 and the storage devices 11a, 11b, 11c, and 11d perform in the initialization operation.

Information that the processing unit 12 generates to establish and manage the zone storage system may be zone storage system setting information. Information that the processing unit 12 generates with regard to the RAID may also be referred to as RAID setting information. The zone storage system setting information or the RAID setting information may be included in metadata of the processing unit 12 such as a file system and may be stored in one or more of the storage devices 11a, 11b, 11c, and 11d. Alternatively, the zone storage system setting information or the RAID setting information may be stored in the storage devices 11a, 11b, 11c, and 11d as metadata of the storage devices 11a, 11b, 11c, and 11d.

When the power is turned off and is then turned on, the processing unit 12 and the storage devices 11a, 11b, 11c, and 11d may identify and use the zone storage system and the RAID established in the storage devices 11a, 11b, 11c, and 11d, based on the zone storage system setting information or the RAID setting information stored in the storage devices 11a, 11b, 11c, and 11d.

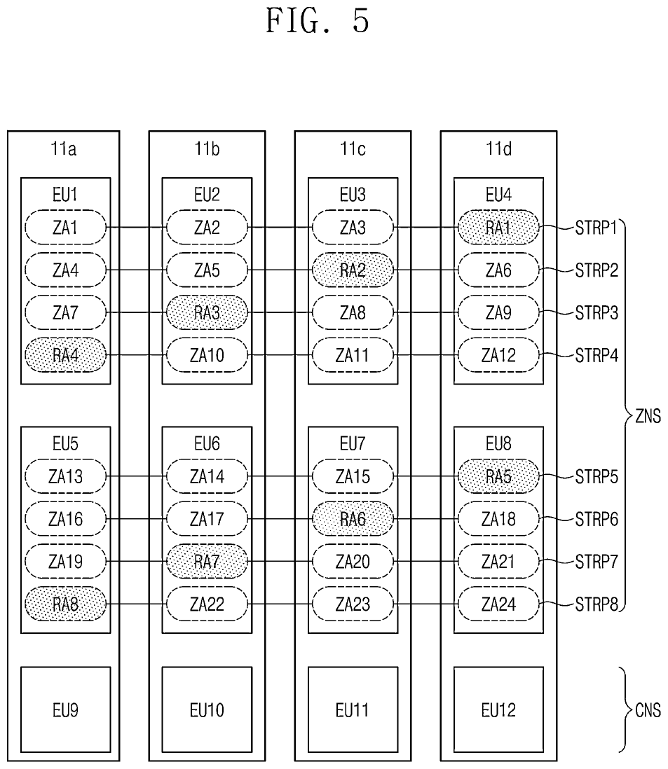

FIG. 5 illustrating an example in which RAID stripes are defined in the storage devices 11a, 11b, 11c, and 11d and logical addresses are assigned thereto. Referring to FIGS. 1, 2, and 5, for example, the first storage device 11a may include a first erase unit EU1, a fifth erase unit EU5, and a ninth erase unit EU9. The first erase unit EU1 and the fifth erase unit EU5 may be used as the first storage area ZNS, and the ninth erase unit EU9 may be used as the second storage area CNS.

The second storage device 11b may include a second erase unit EU2, a sixth erase unit EU6, and a tenth erase unit EU10. The second erase unit EU2 and the sixth erase unit EU6 may be used as the first storage area ZNS, and the tenth erase unit EU10 may be used as the second storage area CNS.

The third storage device 11c may include a third erase unit EU3, a seventh erase unit EU7, and an eleventh erase unit EU11. The third erase unit EU3 and the seventh erase unit EU7 may be used as the first storage area ZNS, and the eleventh erase unit EU11 may be used as the second storage area CNS.

The fourth storage device 11d may include a fourth erase unit EU4, an eighth erase unit EU8, and a twelfth erase unit EU12. The fourth erase unit EU4 and the eighth erase unit EU8 may be used as the first storage area ZNS, and the twelfth erase unit EU12 may be used as the second storage area CNS.

Each of the first to eighth erase units EU1 to EU8 of the first storage area ZNS may include a plurality of memory cells that are used as a y-level cell yLC. Herein, “y” may be a positive integer. Each memory cell that is used as the y-level cell yLC may store “y” bits.

Each of the ninth to twelfth erase units EU9 to EU12 of the second storage area CNS may include a plurality of memory cells that are used as an x-level cell xLC. Each memory cell that is used as the x-level cell xLC may store “x” bits. Herein, “x” may be a positive integer less than “y”. Accordingly, the write speed of the second storage area CNS may be faster than the write speed of the first storage area ZNS, and the read speed of the second storage area CNS may be faster than the read speed of the first storage area ZNS.

The processing unit 12 may define RAID stripes in the first storage areas ZNS of the plurality of storage devices 11a, 11b, 11c, and 11d. For example, the RAID stripes may include first to eighth RAID stripes STRP1 to STRP8.

The processing unit 12 may define the RAID stripes such that one erase unit of each of the plurality of storage devices 11a, 11b, 11c, and 11d corresponds to two or more RAID stripes. The processing unit 12 may define the RAID stripes such that one RAID stripe corresponds to each of the plurality of storage devices 11a, 11b, 11c, and 11d. The memory controller 120 may assign the erase units of the plurality of storage devices 11a, 11b, 11c, and 11d to the RAID stripes defined by the processing unit 12.

For example, the memory controller 120 may assign the first to fourth erase units EU1 to EU4 of the plurality of storage devices 11a, 11b, 11c, and 11d to the first to fourth RAID stripes STRP1 to STRP4.

The first RAID stripe STRP1 may include first to third zone areas ZA1 to ZA3 and a first RAID area RA1. The processing unit 12 may assign continuous logical addresses to the first to third zone areas ZA1 to ZA3 and the first RAID area RA1; alternatively, the processing unit 12 may assign continuous logical addresses to the first to third zone areas ZA1 to ZA3 and may assign continuous logical addresses (e.g., being not continuous to the logical addresses of the first to third zone areas ZA1 to ZA3) to the first RAID area RA1.

The second RAID stripe STRP2 may include fourth to sixth zone areas ZA4 to ZA6 and a second RAID area RA2. The processing unit 12 may assign continuous logical addresses to the fourth to sixth zone areas ZA4 to ZA6 and the second RAID area RA2; alternatively, the processing unit 12 may assign continuous logical addresses to the fourth to sixth zone areas ZA4 to ZA6 and may assign continuous logical addresses (e.g., being not continuous to the logical addresses of the fourth to sixth zone areas ZA4 to ZA6) to the second RAID area RA2.

The third RAID stripe STRP3 may include seventh to ninth zone areas ZA7 to ZA9 and a third RAID area RA3. The processing unit 12 may assign continuous logical addresses to the seventh to ninth zone areas ZA7 to ZA9 and the third RAID area RA3; alternatively, the processing unit 12 may assign continuous logical addresses to the seventh to ninth zone areas ZA7 to ZA9 and may assign continuous logical addresses (e.g., being not continuous to the logical addresses of the seventh to ninth zone areas ZA7 to ZA9) to the third RAID area RA3.

The fourth RAID stripe STRP4 may include tenth to 12th zone areas ZA10 to ZA12 and a fourth RAID area RA4. The processing unit 12 may assign continuous logical addresses to the tenth to 12th zone areas ZA10 to ZA12 and the fourth RAID area RA4; alternatively, the processing unit 12 may assign continuous logical addresses to the tenth to 12th zone areas ZA10 to ZA12 and may assign continuous logical addresses (e.g., being not continuous to the logical addresses of the tenth to 12th zone areas ZA10 to ZA12) to the fourth RAID area RA4.

The first to 12th zone areas ZA1 to ZA12 may be included in the first area of the first storage area ZNS (that is used for the processing unit 12) to store data. For example, the first to fourth RAID areas RA1 to RA4 may be included in the second area of the first storage area ZNS that is used for the processing unit 12 to store the RAID parity.

The first zone area ZA1, the fourth zone area ZA4, the seventh zone area ZA7, and the fourth RAID area RA4 may be included in the first erase unit EU1 of the first storage device 11a. The second zone area ZA2, the fifth zone area ZA5, the third RAID area RA3, and the tenth zone area ZA10 may be included in the second erase unit EU2 of the second storage device 11b. The third zone area ZA3, the second RAID area RA2, the eighth zone area ZA8, and the 11th zone area ZA11 may be included in the third erase unit EU3 of the third storage device 11c. The first RAID area RA1, the sixth zone area ZA6, the ninth zone area ZA9, and the 12th zone area ZA12 may be included in the fourth erase unit EU4 of the fourth storage device 11d.

For example, the memory controller 120 may assign the fifth to eighth erase units EU5 to EU8 of the plurality of storage devices 11a, 11b, 11c, and 11d to the fifth to eighth RAID stripes STRP5 to STRP8.

The fifth RAID stripe STRP5 may include 13th to 15th zone areas ZA13 to ZA15 and a fifth RAID area RA5. The processing unit 12 may assign continuous logical addresses to the 13th to 15th zone areas ZA13 to ZA15 and the fifth RAID area RA5; alternatively, the processing unit 12 may assign continuous logical addresses to the 13th to 15th zone areas ZA13 to ZA15 and may assign continuous logical addresses (e.g., being not continuous to the logical addresses of the 13th to 15th zone areas ZA13 to ZA15) to the fifth RAID area RA5.

The sixth RAID stripe STRP6 may include 16th to 18th zone areas ZA16 to ZA18 and a sixth RAID area RA6. The processing unit 12 may assign continuous logical addresses to the 16th to 18th zone areas ZA16 to ZA18 and the fifth RAID area RA6; alternatively, the processing unit 12 may assign continuous logical addresses to the 16th to 18th zone areas ZA16 to ZA18 and may assign continuous logical addresses (e.g., being not continuous to the logical addresses of the 16th to 18th zone areas ZA16 to ZA18) to the sixth RAID area RA6.

The seventh RAID stripe STRP7 may include 19th to 21st zone areas ZA19 to ZA21 and a seventh RAID area RA7. The processing unit 12 may assign continuous logical addresses to the 19th to 21st zone areas ZA19 to ZA21 and the seventh RAID area RA7; alternatively, the processing unit 12 may assign continuous logical addresses to the 19th to 21st zone areas ZA19 to ZA21 and may assign continuous logical addresses (e.g., being not continuous to the logical addresses of the 19th to 21st zone areas ZA19 to ZA21) to the seventh RAID area RA7.

The eighth RAID stripe STRP8 may include 22nd to 24th zone areas ZA22 to ZA24 and an eighth RAID area RA8. The processing unit 12 may assign continuous logical addresses to the 22nd to 24th zone areas ZA22 to ZA24 and the eighth RAID area RA8; alternatively, the processing unit 12 may assign continuous logical addresses to the 22nd to 24th zone areas ZA22 to ZA24 and may assign continuous logical addresses (e.g., being not continuous to the logical addresses of the 22nd to 24th zone areas ZA22 to ZA24) to the eighth RAID area RA8.

The 13th to 24th zone areas ZA13 to ZA24 may be included in the first area of the first storage area ZNS that is used for the processing unit 12 to store data. The fifth to eighth RAID areas RA5 to RA8 may be included in the second area of the first storage area ZNS that is used for the processing unit 12 to store the RAID parity.

The 13th zone area ZA13, the 16th zone area ZA16, the 19th zone area ZA19, and the eighth RAID area RA8 may be included in the fifth erase unit EU5 of the first storage device 11a. The 14th zone area ZA14, the 17th zone area ZA17, the seventh RAID area RA7, and the 22nd zone area ZA22 may be included in the sixth erase unit EU6 of the second storage device 11b. The 15th zone area ZA15, the sixth RAID area RA6, the 20th zone area ZA20, and the 23th zone area ZA23 may be included in the seventh erase unit EU7 of the third storage device 11c. The fifth RAID area RA5, the 18th zone area ZA18, the 21st zone area ZA21, and the 24th zone area ZA24 may be included in the eighth erase unit EU8 of the fourth storage device 11d.

As described above, the processing unit 12 may establish the RAID based on the erase units of the plurality of storage devices 11a, 11b, 11c, and 11d. In at least one embodiment, the processing unit 12 may establish RAID 5 based on the erase units of the plurality of storage devices 11a, 11b, 11c, and 11d, but the embodiments of the present disclosure are not limited to RAID 5. For example, the processing unit 12 may establish RAID 4 by using one of the plurality of storage devices 11a, 11b, 11c, and 11d to store the RAID parity.

The processing unit 12 may assign continuous logical addresses to each of the ninth erase unit EU9, the tenth erase unit EU10, the eleventh erase unit EU11, and the twelfth erase unit EU12 of the storage devices 11a, 11b, 11c, and 11d, which are used as the second storage area CNS. For example, the logical addresses of the ninth erase unit EU9, the tenth erase unit EU10, the eleventh erase unit EU11, or the twelfth erase unit EU12 may not be continuous to the logical addresses of the first storage area ZNS. The logical addresses of the ninth erase unit EU9, the tenth erase unit EU10, the eleventh erase unit EU11, or the twelfth erase unit EU12 may not be continuous to logical addresses of any other erase unit of the second storage area CNS.

In at least one embodiment, the description is given as logical addresses are assigned to the first to eighth erase units EU1 to EU8 of the first storage area ZNS and logical addresses are assigned to the ninth to twelfth erase units EU9 to EU12 of the second storage area CNS. However, logical addresses may be assigned to a logical storage space of the first storage area ZNS and a logical storage space of the second storage area CNS, rather than physical erase units. The memory controller 120 may dynamically map a plurality of erase units to logical addresses.

In at least one embodiment, the entire storage space of erase units that the memory controller 120 uses for the mapping of the first storage area ZNS may be greater than the storage space of the first storage area ZNS that the processing unit 12 uses (e.g., the entire storage space of erase units that the memory controller 120 uses may include a first reserved space). The memory controller 120 may improve the performance or reliability of the storage device 100 by using the first reserved space of the first storage area ZNS.

Likewise, the entire storage space of erase units that the memory controller 120 uses for the mapping of the second storage area CNS may be greater than the storage space of the second storage area CNS that the processing unit 12 uses (e.g., the entire storage space of erase units that the memory controller 120 uses may include a second reserved space). The memory controller 120 may improve the performance or reliability of the storage device 100 by using the second reserved space of the second storage area CNS.

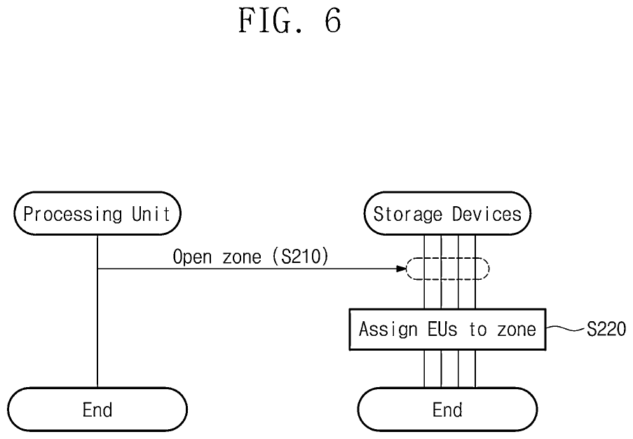

FIG. 6 illustrates an example in which the electronic device 10 opens a zone in the plurality of storage devices 11a, 11b, 11c, and 11d. Referring to FIGS. 1 and 6, at operation S210, the processing unit 12 transmits an open zone request to the storage devices 11a, 11b, 11c, and 11d. In at least one embodiment, the processing unit 12 may provide a zone number and a start logical address to the storage devices 11a, 11b, 11c, and 11d. Alternatively, the processing unit 12 may provide a zone number and different start logical addresses to the storage devices 11a, 11b, 11c, and 11d.

At operation S220, based on the open zone request, the storage devices 11a, 11b, 11c, and 11d open a zone by assigning a zone to erase units. The storage devices 11a, 11b, 11c, and 11d may assign erase units to a zone based on the zone number and the start logical address (or start logical addresses) and may map the logical addresses to physical addresses.

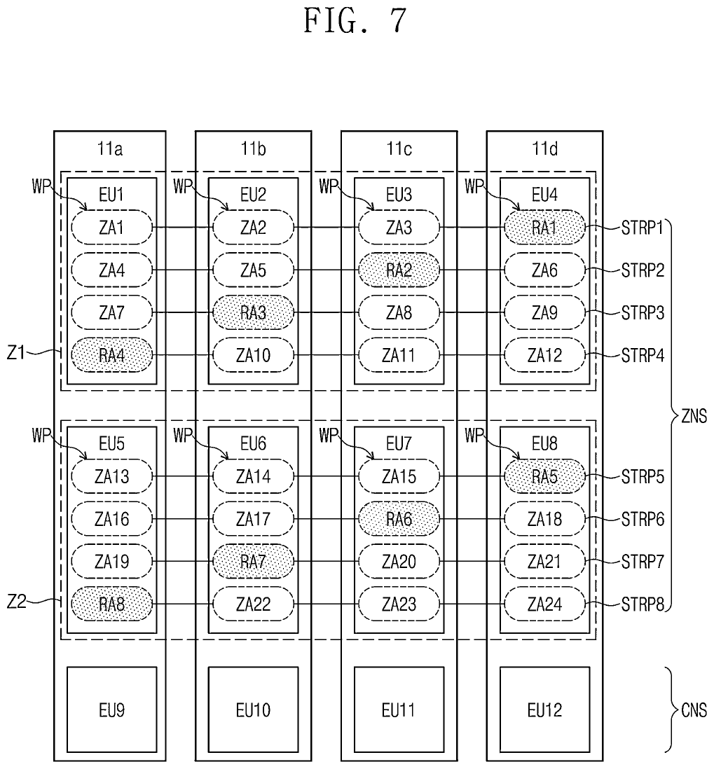

FIG. 7 illustrates an example in which a first zone Z1 and a second zone Z2 are generated in the storage devices 11a, 11b, 11c, and 11d. Referring to FIGS. 1, 2, and 7, in at least one embodiment, one zone may correspond to four erase units.

The storage devices 11a, 11b, 11c, and 11d may assign the first to fourth erase units EU1 to EU4 respectively included in the storage devices 11a, 11b, 11c, and 11d to the first zone Z1. Continuous logical addresses may be assigned to the first to 12th zone areas ZA1 to ZA12 that are included in the first to fourth RAID stripes STRP1 to STRP4 defined in the first to fourth erase units EU1 to EU4.

Continuous logical addresses may be assigned to each of the first to fourth RAID areas RA1 to RA4 that are included in the first to fourth RAID stripes STRP1 to STRP4 defined in the first to fourth erase units EU1 to EU4. Logical addresses of one RAID area may be continuous or discontinuous to logical addresses of any other RAID area and may be continuous or discontinuous to logical addresses of a zone area.

A write pointer WP of the first storage device 11a may point out the first (or LSB) logical address among logical addresses where data are not written, for example, a logical address of the first zone area ZA1. Data may be written in a storage space of the first storage device 11a, which is pointed out by the write pointer WP. When the data is written in the storage space pointed out by the write pointer WP, the first storage device 11a may update the write pointer WP to point out the first (or least significant bit (LSB)) logical address belonging to the first storage device 11a from among the logical addresses of the first zone Z1.

Likewise, the write pointer WP of the second storage device 11b may point out the second zone area ZA2, and the write pointer WP of the third storage device 11c may point out the third zone area ZA3.

In each RAID stripe, when logical addresses of the RAID area are continuous to logical addresses of zone areas, the RAID area may also be pointed out by the write pointer WP. For example, when the logical addresses of the first RAID area RA1 are continuous to the logical addresses of the third zone area ZA3, the write pointer WP of the fourth storage device 11d may point out the first RAID area RA1.

In each RAID stripe, when logical addresses of the RAID area are managed to be independent of (or are not continuous to) logical addresses of zone areas, the RAID area may not be pointed out by the write pointer WP. For example, the write pointer WP of the fourth storage device 11d may skip the first RAID area RA1 and may point out the sixth zone area ZA6 (or may jump to the sixth zone area ZA6).

The storage devices 11a, 11b, 11c, and 11d may assign the fifth to eighth erase units EU5 to EU8 respectively included in the storage devices 11a, 11b, 11c, and 11d to the second zone Z2. Continuous logical addresses may be assigned to the 13th to 24th zone areas ZA13 to ZA24 that are included in the fifth to eighth RAID stripes STRP5 to STRP8 defined in the fifth to eighth erase units EU5 to EU8.

Continuous logical addresses may be assigned to each of the fifth to eighth RAID areas RA5 to RA8 that are included in the fifth to eighth RAID stripes STRP5 to STRP8 defined in the fifth to eighth erase units EU5 to EU8. Logical addresses of one RAID area may be continuous or discontinuous to logical addresses of any other RAID area and may be continuous or discontinuous to logical addresses of a zone area.

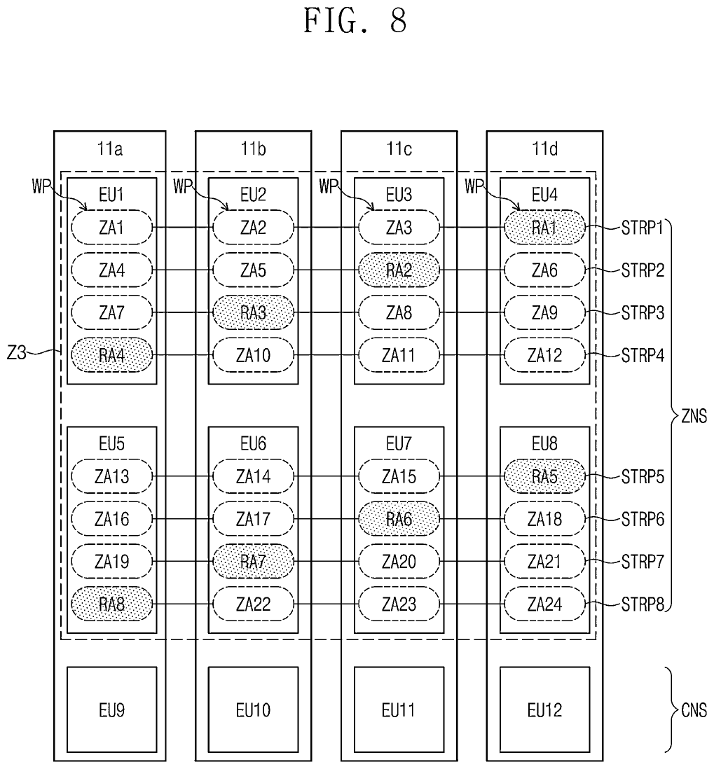

FIG. 8 illustrates an example in which a third zone Z3 is generated in the storage devices 11a, 11b, 11c, and 11d. Referring to FIGS. 1, 2, and 8, in at least one embodiment, one zone may correspond to eight erase units.

The storage devices 11a, 11b, 11c, and 11d may assign the first to fourth erase units EU1 to EU4 respectively included in the storage devices 11a, 11b, 11c, and 11d and the fifth to eighth erase units EU5 to EU8 respectively included in the storage devices 11a, 11b, 11c, and 11d to the third zone Z3. Continuous logical addresses may be assigned to the first to 24th zone areas ZA1 to ZA24 included in the first to eighth RAID stripes STRP1 to STRP8 defined in the first to eighth erase units EU1 to EU8.

Continuous logical addresses may be assigned to each of the first to eighth RAID areas RA1 to RA8 that are included in the first to eighth RAID stripes STRP1 to STRP8 defined in the first to eighth erase units EU1 to EU8. Logical addresses of one RAID area may be continuous or discontinuous to logical addresses of any other RAID area and may be continuous or discontinuous to logical addresses of a zone area.

In at least one embodiment, the zone storage system setting information may include information indicating whether to fix or change a zone size. When the zone size is fixed, the number of erase units assigned to one zone may be adjusted and/or fixed (e.g., corresponding to the example of FIG. 7 or 8). When the zone size is variable, the number of erase units assigned to one zone may be variable (e.g., corresponding to the example of FIGS. 7 and 8).

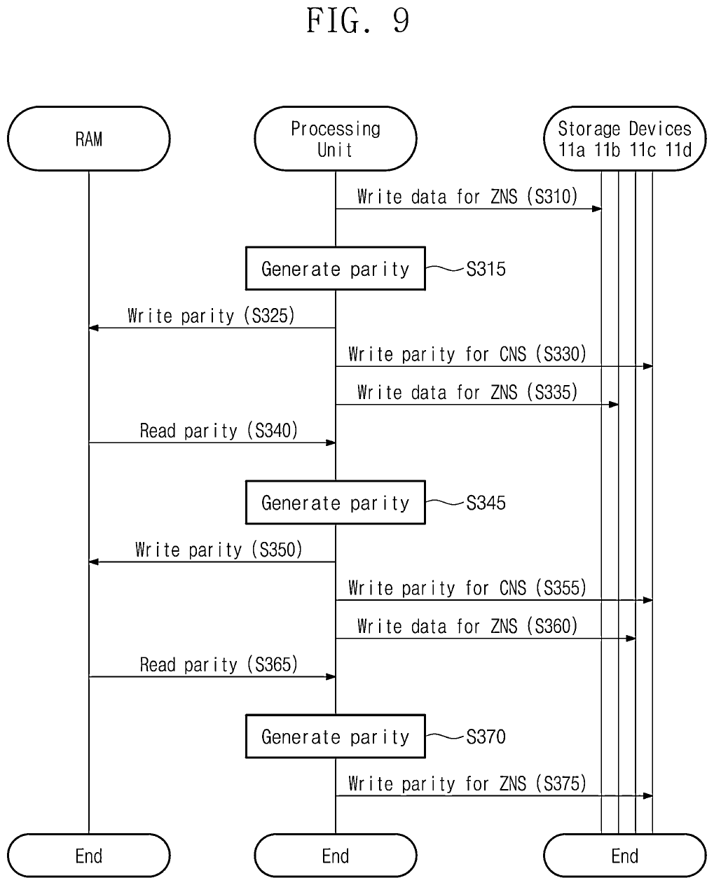

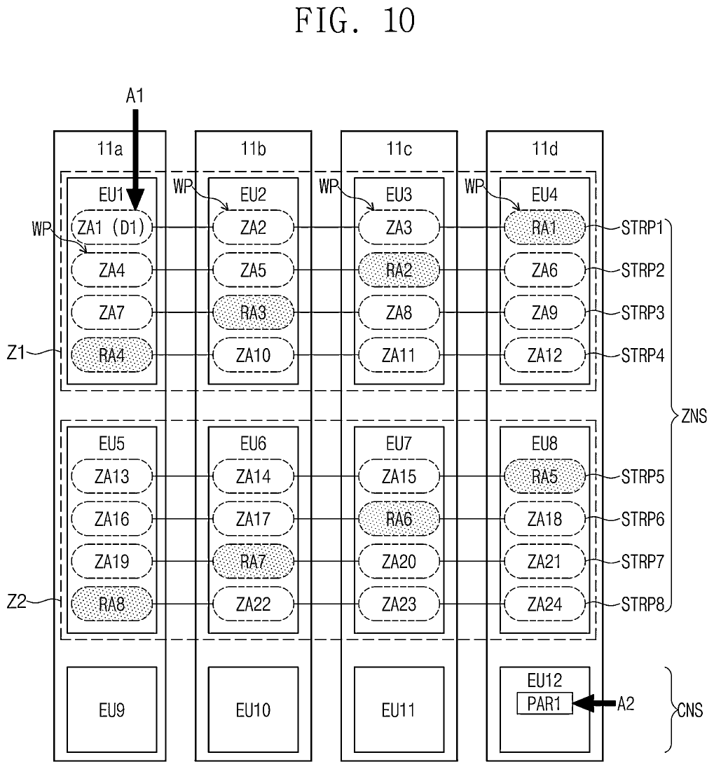

FIG. 9 illustrates an example in which the electronic device 10 according to at least one embodiment of the present disclosure writes data in the storage devices 11a, 11b, 11c, and 11d. FIGS. 10, 11, and 12 illustrate examples in which data are written in the storage devices 11a, 11b, 11c, and 11d depending on the method of FIG. 9.

Referring to FIGS. 1, 2, 9, and 10, at operation S310, the processing unit 12 writes data in the first storage area ZNS of the storage devices 11a, 11b, 11c, and 11d. In at least one embodiment, as shown by a first arrow A1 in FIG. 10, the processing unit 12 may write first data D1 in the first zone area ZA1 of the first storage device 11a. For example, the processing unit 12 may write the first data D1 based on a write request received from an external host or an application server.

The first data D1 may include original data and an error correction parity, and the error correction parity may be generated from the original data by, e.g., the error correction code block 127 of the memory controller 120. The error correction parity may be used for the error correction code block 127 to correct an error. As the processing unit 12 writes the first data D1 in the first zone area ZA1 of the first storage device 11a, the write pointer WP of the first zone Z1 of the first storage device 11a may point out the fourth zone area ZA4 corresponding to a next logical address.

At operation S315, the processing unit 12 generates a parity. For example, the processing unit 12 may generate a RAID parity (e.g., an original RAID parity) from the first data D1 (e.g., the original data of the first data D1). The RAID parity may be used for the processing unit 12 to recover data of a RAID stripe. For example, when an error uncorrectable by the error correction code block 127 occurs in data of a specific zone area of a specific RAID stripe, the processing unit 12 may recover data (e.g., original data), in which the uncorrectable error occurs, by using data (e.g., original data) of the remaining zone areas of the specific RAID stripe and the RAID parity (e.g., the original RAID parity).

In at least one embodiment, the data and the RAID parity that are processed by the processing unit 12 may be the original data and the original RAID parity, and the data and the RAID parity that are written in the storage devices 11a, 11b, 11c, and 11d may be the data to which the error correction parity is added and the RAID parity. The data and the RAID parity that the processing unit 12 reads from the storage devices 11a, 11b, 11c, and 11d may be the data error-corrected by using the error correction parity (e.g., the original data or the data including an uncorrected error) and the RAID parity (e.g., the original RAID parity or the data including an uncorrected error).

Below, unless otherwise clearly stated, even though the same reference number or the same reference sign is used, the data or the RAID parity written in the storage devices 11a, 11b, 11c, and 11d may further include the error correction parity of the error correction code block 127, and the data or the RAID parity that are used in the processing unit 12 or the random access memory 13 may mean the error correction parity of the error correction code block 127 is not included.

In at least one embodiment, the processing unit 12 may generate a new RAID parity by performing an exclusive OR (XOR) operation on an existing RAID parity and data. Because the first data D1 are first written in the first RAID stripe STRP1, an existing RAID stripe may include values of “0” or values of “1” as an initial value. The processing unit 12 may calculate the first data D1 or inverse data of the first data D1 as the RAID parity by performing the XOR operation on the initial value and the first data D1. Because the RAID parity generated from the first data D1 is based on only data of the first zone area ZA1 among the first to third zone areas ZA1 to ZA3, the RAID parity may be a first intermediate RAID parity.

At operation S325, the processing unit 12 writes a parity in the random access memory 13. For example, the processing unit 12 may write a first intermediate RAID parity generated from the first data D1 in the random access memory 13.

At operation S330, the processing unit 12 writes the parity in the second storage area CNS. For example, as shown by a second arrow A2 in FIG. 10, the processing unit 12 may write a first intermediate RAID parity PAR1 generated from the first data D1 in the second storage area CNS of the fourth storage device 11d, which corresponds to the first RAID area RA1 of the first RAID stripe STRP1. The processing unit 12 may complete the write of the first data D1 by writing the first intermediate RAID parity PAR1 in the second storage area CNS of the fourth storage device 11d.

In operation S310 to operation S330, a data target in which the processing unit 12 writes the first data D1 may be the first zone area ZA1 of the first storage device 11a, and a parity target in which the processing unit 12 writes the first intermediate RAID parity PAR1 may be the second storage area CNS of the fourth storage device 11d, but the embodiments are not limited thereto.

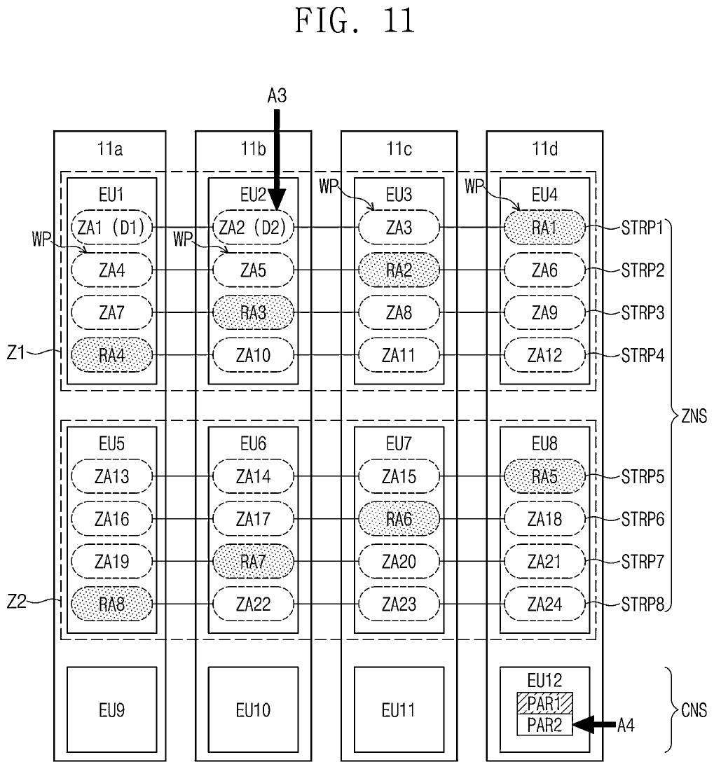

At operation S335, the processing unit 12 writes data in the first storage area ZNS of the storage devices 11a, 11b, 11c, and 11d. In at least one embodiment, as shown by a third arrow A3 in FIG. 11, the processing unit 12 may write second data D2 in the second zone area ZA2 of the second storage device 11b. For example, the processing unit 12 may write the second data D2 based on a write request received from the external host or the application server.

The second data D2 may include original data and an error correction parity, and the error correction parity may be generated from the original data by the error correction code block 127 of the memory controller 120. As the processing unit 12 writes the second data D2 in the second zone area ZA2 of the second storage device 11b, the write pointer WP of the first zone Z1 of the second storage device 11b may point out the fifth zone area ZA5 corresponding to a next logical address.

At operation S340, the processing unit 12 reads the parity from the random access memory 13. For example, the processing unit 12 may read the first intermediate RAID parity PAR1 generated from the first data D1 from the random access memory 13.

At operation S345, the processing unit 12 generates a parity. For example, the processing unit 12 may generate a new RAID parity by performing an XOR operation on an existing RAID parity and data. The processing unit 12 may calculate the RAID parity by performing the XOR operation on the first intermediate RAID parity PAR1 and the second data D2. The RAID parity generated from the first intermediate RAID parity PAR1 and the second data D2 may be a second intermediate RAID parity.

AT operation S350, the processing unit 12 writes the parity in the random access memory 13. For example, the processing unit 12 may write the second intermediate RAID parity in the random access memory 13.

At operation S355, the processing unit 12 writes the parity in the second storage area CNS. For example, as shown by a fourth arrow A4 in FIG. 11, the processing unit 12 may write a second intermediate RAID parity PAR2 in the second storage area CNS of the fourth storage device 11d, which corresponds to the first RAID area RA1 of the first RAID stripe STRP1. The processing unit 12 may complete the write of the second data D2 by writing the second intermediate RAID parity PAR2 in the second storage area CNS of the fourth storage device 11d.

In at least one embodiment, the processing unit 12 may write the second intermediate RAID parity PAR2 in the second storage area CNS of the fourth storage device 11d by using a logical address identical to the logical address of the first intermediate RAID parity PAR1. As the second intermediate RAID parity PAR2 is written, the fourth storage device 11d may invalidate the first intermediate RAID parity PAR1.

As another example, the processing unit 12 may write the second intermediate RAID parity PAR2 in the second storage area CNS of the fourth storage device 11d by using a logical address different from the logical address of the first intermediate RAID parity PAR1. Even though the second intermediate RAID parity PAR2 is written, the fourth storage device 11d may maintain the first intermediate RAID parity PAR1 as valid data.

In operation S335 to operation S355, a data target in which the processing unit 12 writes the second data D2 may be the second zone area ZA2 of the second storage device 11b, and a parity target in which the processing unit 12 writes the second intermediate RAID parity PAR2 may be the second storage area CNS of the fourth storage device 11d.

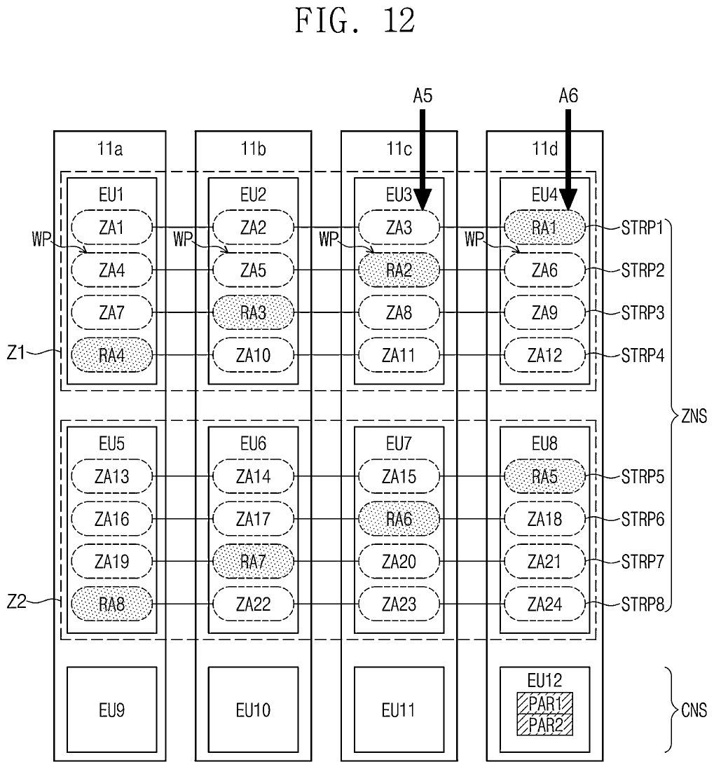

At operation S360, the processing unit 12 writes data in the first storage area ZNS of the storage devices 11a, 11b, 11c, and 11d. In at least one embodiment, as shown by a fifth arrow A5 in FIG. 12, the processing unit 12 may write third data D3 in the third zone area ZA3 of the third storage device 11c. For example, the processing unit 12 may write the third data D3 based on a write request received from the external host or the application server.

The third data D3 may include original data and an error correction parity, and the error correction parity may be generated from the original data by the error correction code block 127 of the memory controller 120. As the processing unit 12 writes the third data D3 in the third zone area ZA3 of the third storage device 11c, the write pointer WP of the first zone Z1 of the third storage device 11c may point out the second RAID area RA2 corresponding to a next logical address.

At operation S365, the processing unit 12 reads the parity from the random access memory 13. For example, the processing unit 12 may read the second intermediate RAID parity PAR2 from the random access memory 13.

At operation S370, the processing unit 12 generates a parity. For example, the processing unit 12 may generate a new RAID parity by performing an XOR operation on an existing RAID parity and data. The processing unit 12 may calculate a RAID parity (e.g., a first RAID parity) by performing the XOR operation on the second intermediate RAID parity PAR2 and the third data D3. Because the first RAID parity generated from the second intermediate RAID parity PAR2 and the third data D3 is based on the data of the first to third zone areas ZA1 to ZA3 (e.g., all the zone areas) of the first RAID stripe STRP1, the first RAID parity may be a final RAID parity.

At operation S375, the processing unit 12 writes the parity in the first storage area ZNS. For example, as shown by a sixth arrow A6 in FIG. 12, the processing unit 12 may write a first RAID parity in the first RAID area RA1 of the first RAID stripe STRP1. The processing unit 12 may complete the write of the third data D3 by writing the first RAID parity in the first RAID area RA1 of the first RAID stripe STRP1.

In at least one embodiment, when the processing unit 12 writes the second intermediate RAID parity PAR2 in the second storage area CNS of the fourth storage device 11d by using a logical address different from the logical address of the second intermediate RAID parity PAR2, the processing unit 12 may write the first RAID parity in the first RAID area RA1 of the first RAID stripe STRP1 and may then request the fourth storage device 11d to invalidate the first intermediate RAID parity PAR1 and the second intermediate RAID parity PAR2.

In operation S360 to operation S375, a data target in which the processing unit 12 writes the third data D3 may be the third zone area ZA3 of the third storage device 11c, and a parity target in which the processing unit 12 writes the first RAID parity may be the first RAID area RA1 of the fourth storage device 11d.

Likewise, in each of the second to fourth RAID stripes STR2 to STRP4, the processing unit 12 may write data in zone areas of data targets based on sequential logical addresses; in this case, the processing unit 12 may write an intermediate RAID parity in the random access memory 13 and the second storage area CNS of a storage device corresponding to a RAID area and may write a final RAID parity in the RAID area.

The processing unit 12 may read an intermediate RAID parity stored in the random access memory 13 and may calculate a new intermediate RAID parity or a final RAID parity. Accordingly, a speed at which the processing unit 12 calculates the RAID parity may be improved.

Additionally, since the intermediate RAID parity stored in the random access memory 13 may be lost when a power of the electronic device 10 is turned off or an error occurs in the intermediate RAID parity stored in the random access memory 13, but the intermediate RAID parity is also written in the second storage area CNS, when a power is turned on after a power-off event or when an error occurs in the intermediate RAID parity stored in the random access memory 13, the processing unit 12 may recover (or read) the intermediate RAID parity without losing the intermediate RAID parity. Accordingly, the reliability of the electronic device 10 may be improved.

In the zone(s) assigned to the storage devices 11a, 11b, 11c, and 11d, only an additional write based on sequential logical addresses is permitted, and an overwrite operation is not permitted. Because the intermediate RAID parity or the RAID parity replaces a previous intermediate RAID parity, the overwrite operation (e.g., an overwrite operation based on the same logical address) or an additional write operation (e.g., a write operation of a new intermediate RAID parity or a final RAID parity) is required. The overwrite operation may be prohibited in the zone storage system, and the additional write operation for the RAID area may hinder the alignment of the RAID stripe.

As described above, there may be provided an electronic device that has an improved speed and improved reliability while satisfying both a rule of the zone storage system and a rule of the RAID, by writing the intermediate RAID parity in not the first storage area ZNS but the second storage area CNS and writing only the final RAID parity in the first storage area ZNS.

For example, when the write pointer WP skips the RAID area without pointing out the RAID area, the write pointer WP of the fourth storage device 11d may point out the sixth zone area ZA6, not the first RAID area RA1. When the processing unit 12 writes the first RAID parity in the first RAID area RA1, the write pointer WP of the fourth storage device 11d may be maintained. Also, when the processing unit 12 writes the third data D3 in the third zone area ZA3, the write pointer WP of the third storage device 11c may jump to the eighth zone area ZA8 without pointing out the second RAID area RA2.

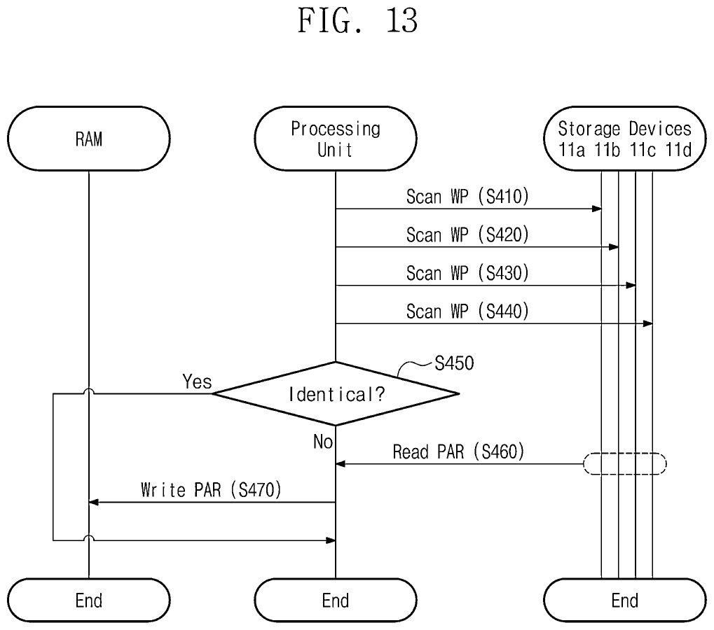

FIG. 13 illustrates an example in which the electronic device 10 recovers an intermediate RAID parity when a power is turned on after a power-off event. Referring to FIGS. 1, 2, and 13, at operation S410, the processing unit 12 scans the write pointer WP of the first storage device 11a. At operation S420, the processing unit 12 scans the write pointer WP of the second storage device 11b. At operation S430, the processing unit 12 may scan the write pointer WP of the third storage device 11c. At operation S440, the processing unit 12 scans the write pointer WP of the fourth storage device 11d.

At operation S450, the processing unit 12 determines whether the write pointers WP of the storage devices 11a, 11b, 11c, and 11d are identical (e.g., the same and/or substantially similar). For example, the processing unit 12 may determine whether the write pointers WP of the storage devices 11a, 11b, 11c, and 11d point out the same position offset (or point out the same RAID stripe).

When the write pointers WP of the storage devices 11a, 11b, 11c, and 11d point out the same position offset (or point out the same RAID stripe), as described with reference to FIGS. 8 and 12, the RAID parity that is not written in the RAID area may not exist, or the intermediate RAID parity that is being used before a power-off event may not exist. Accordingly, the processing unit 12 may end the process without recovering (or reading) an intermediate RAID parity.

When the write pointers WP of the storage devices 11a, 11b, 11c, and 11d do not point out the same position offset (or do not point out the same RAID stripe), as described with reference to FIGS. 10 and 11, the RAID parity that is not written in the RAID area may exist, or the intermediate RAID parity that is being used before a power-off event may exist.

Accordingly, at operation S460, the processing unit 12 reads the intermediate RAID parity PAR from the storage devices 11a, 11b, 11c, and 11d. For example, the processing unit 12 may read the intermediate RAID parity PAR (e.g., the latest intermediate RAID parity) from the second storage area CNS being a parity target of a RAID stripe where data are being written.

Afterwards, at operation S470, the processing unit 12 stores the intermediate RAID parity PAR in the random access memory 13. The intermediate RAID parity PAR stored in the random access memory 13 may be used for the processing unit 12 to generate a final RAID parity.

In at least one embodiment, when the write pointer WP skips the RAID area, at operation S450, the processing unit 12 determines whether three write pointers are identical, for example, may determine the three write pointers point out the same position offset (or point out the same RAID stripe).

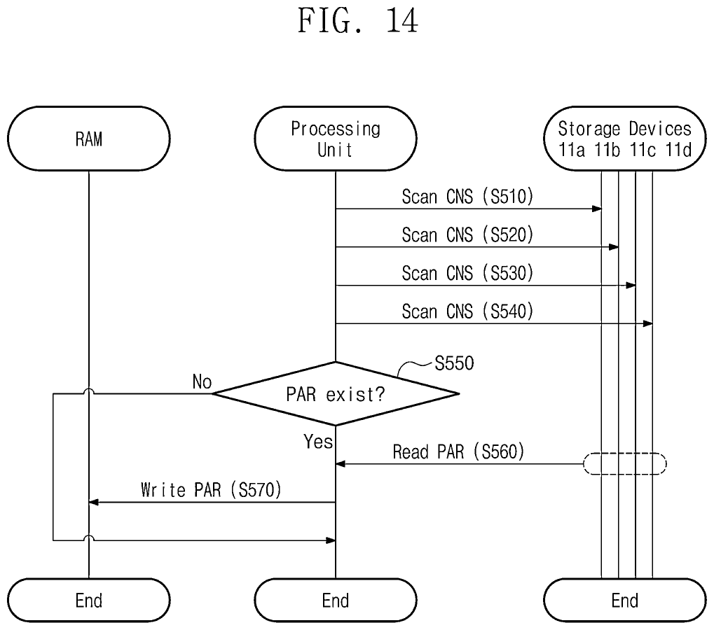

FIG. 14 illustrates another example in which the electronic device 10 recovers an intermediate RAID parity when a power is turned on after a power-off event. Referring to FIGS. 1, 2, and 14, at operation S510, the processing unit 12 may scan the second storage area CNS of the first storage device 11a. At operation S520, the processing unit 12 scans the second storage area CNS of the second storage device 11b. At operation S530, the processing unit 12 scans the second storage area CNS of the third storage device 11c. At operation S540, the processing unit 12 scans the second storage area CNS of the fourth storage device 11d.

At operation S550, the processing unit 12 determines whether the intermediate RAID parity PAR is present in the second storage area CNS of the storage devices 11a, 11b, 11c, and 11d. For example, the processing unit 12 may determine whether the intermediate RAID parity PAR being in a valid state is present in the second storage area CNS of the storage devices 11a, 11b, 11c, and 11d.

When the intermediate RAID parity PAR being in a valid state is absent from the second storage area CNS of the storage devices 11a, 11b, 11c, and 11d, as described with reference to FIGS. 8 and 12, the RAID parity that is not written in the RAID area may not exist, and/or the intermediate RAID parity that is being used before a power-off event may not exist. Accordingly, the processing unit 12 may end the process without recovering (or reading) an intermediate RAID parity.

Alternatively, when the intermediate RAID parity PAR being in a valid state is present in the second storage area CNS of the storage devices 11a, 11b, 11c, and 11d, as described with reference to FIGS. 10 and 11, the RAID parity that is not written in a RAID area may exist, or the intermediate RAID parity that is being used before a power-off event may exist.

Accordingly, at operation S560, the processing unit 12 reads the intermediate RAID parity PAR from the storage devices 11a, 11b, 11c, and 11d. For example, the processing unit 12 may read the intermediate RAID parity PAR (e.g., the latest intermediate RAID parity) from the second storage area CNS being a parity target of a RAID stripe where data are being written.

Afterwards, at operation S570, the processing unit 12 may store the intermediate RAID parity PAR in the random access memory 13. The intermediate RAID parity PAR stored in the random access memory 13 may be used for the processing unit 12 to generate a final RAID parity.

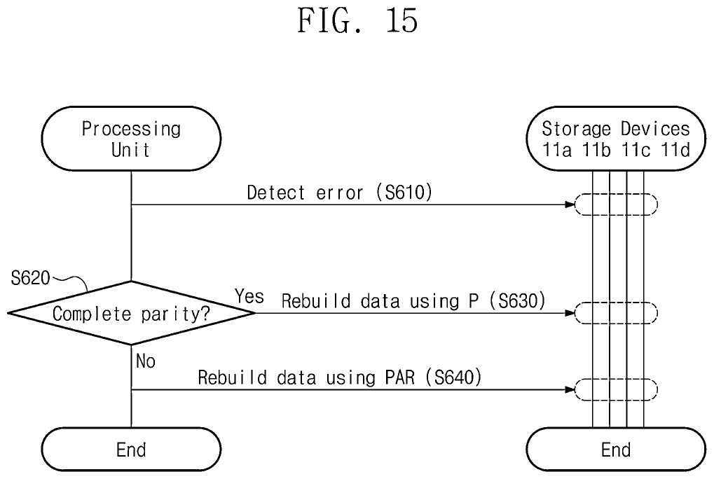

FIG. 15 illustrating an example in which the electronic device 10 recovers data by using an intermediate RAID parity or a RAID parity. Referring to FIGS. 1, 2, and 15, at operation S610, the processing unit 12 detects an error in the data written in the storage devices 11a, 11b, 11c, and 11d. For example, when an error uncorrectable by the error correction code block 127 occurs in one zone area of a RAID stripe, the processing unit 12 may detect the error.

At operation S620, the processing unit 12 determines whether a complete parity is present in the RAID stripe where the error is detected. For example, the processing unit 12 may determine whether a final RAID parity is present in the RAID area of the RAID stripe where the error is detected.

When the final RAID parity is present in the RAID area of the RAID stripe where the error is detected, at operation S630, the processing unit 12 rebuilds data by using the final RAID parity “P”. For example, the processing unit 12 may read the final RAID parity “P” and data of zone areas where an error is not detected, from the RAID stripe where the error is detected. The processing unit 12 may recover the data in which the error is detected, by performing the XOR operation on the read data.

When the complete parity is absent from the RAID area of the RAID stripe where the error is detected, at operation S640, the processing unit 12 rebuilds data by using the intermediate RAID parity PAR. For example, the processing unit 12 may read the intermediate RAID parity PAR from the second storage area CNS where the error is detected or from the random access memory 13 and may read data of a zone area(s) where an error is not detected, from the RAID stripe where the error is detected. The processing unit 12 may recover the data in which the error is detected, by performing the XOR operation on the read data.

After recovering the data, the processing unit 12 may perform a process following the data recovery. For example, the processing unit 12 may write the recovered data as new data in the same zone. As another example, the processing unit 12 may open a new zone and copy data (e.g., the remaining data other than the data where the error is detected) of a zone including the RAID stripe where the error is detected and the recovered data to the new zone.

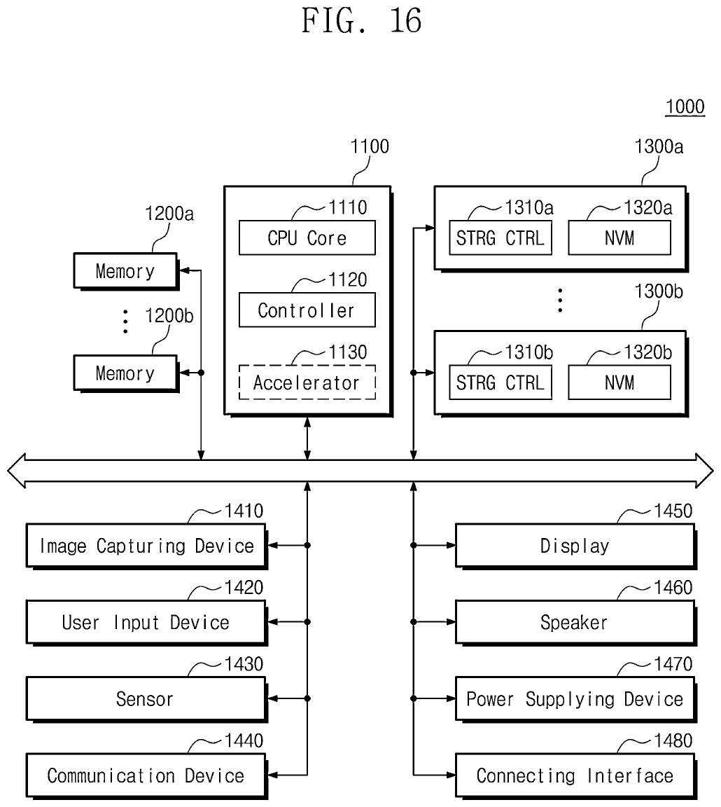

FIG. 16 is a diagram of a system 1000 to which a storage device is applied, according to at least one embodiment. The system 1000 of FIG. 16 may basically be a mobile system, such as a portable communication terminal (e.g., a mobile phone), a smartphone, a tablet personal computer (PC), a wearable device, a healthcare device, or an Internet of things (IoT) device. However, the system 1000 of FIG. 16 is not necessarily limited to the mobile system and may be a PC, a laptop computer, a server, a media player, or an automotive device (e.g., a navigation device).

Referring to FIG. 16, the system 1000 may include a main processor 1100, memories (e.g., 1200a and 1200b), and a plurality of storage devices (e.g., 1300a and 1300b). In addition, the system 1000 may include at least one of an image capturing device 1410, a user input device 1420, a sensor 1430, a communication device 1440, a display 1450, a speaker 1460, a power supplying device 1470, a connecting interface 1480, and/or the like.

The main processor 1100 may be configured to control all operations of the system 1000, more specifically, operations of other components included in the system 1000. The main processor 1100 may be implemented as a general-purpose processor, a dedicated processor, an application processor, and/or the like.

The main processor 1100 may include at least one CPU core 1110 and further include a controller 1120 configured to control the memories 1200a and 1200b and/or the storage devices 1300a and 1300b. In some embodiments, the main processor 1100 may further include an accelerator 1130, which is a dedicated circuit for a high-speed data operation, such as an artificial intelligence (AI) data operation. The accelerator 1130 may include a graphics processing unit (GPU), a neural processing unit (NPU), a data processing unit (DPU), and/or the like; and, in at least one embodiment, may be implemented as a chip that is physically separate from the other components of the main processor 1100.

The memories 1200a and 1200b may be used as main memory devices of the system 1000. Although each of the memories 1200a and 1200b may include a volatile memory, such as static random access memory (SRAM) and/or dynamic RAM (DRAM), each of the memories 1200a and 1200b include non-volatile memory, such as a flash memory, phase-change RAM (PRAM) and/or resistive RAM (RRAM). The memories 1200a and 1200b may be implemented in the same package as the main processor 1100.

The storage devices 1300a and 1300b may serve as non-volatile storage devices configured to store data regardless of whether power is supplied thereto, and have larger storage capacity than the memories 1200a and 1200b. The storage devices 1300a and 1300b may respectively include storage controllers (STRG CTRL) 1310a and 1310b and NVM(Non-Volatile Memory)s 1320a and 1320b configured to store data via the control of the storage controllers 1310a and 1310b. Although the NVMs 1320a and 1320b may include flash memories having a two-dimensional (2D) structure or a three-dimensional (3D) V-NAND structure, the NVMs 1320a and 1320b may include other types of NVMs, such as PRAM and/or RRAM.

The storage devices 1300a and 1300b may be physically separated from the main processor 1100 and included in the system 1000 and/or implemented in the same package as the main processor 1100. In addition, the storage devices 1300a and 1300b may have types of solid-state devices (SSDs) or memory cards and be removably combined with other components of the system 1000 through an interface, such as the connecting interface 1480 that will be described below. The storage devices 1300a and 1300b may be devices to which a standard protocol, such as a universal flash storage (UFS), an embedded multi-media card (eMMC), or a non-volatile memory express (NVMe), is applied, without being limited thereto.

The image capturing device 1410 may be configured to capture still images or moving images. The image capturing device 1410 may include, e.g., a camera, a camcorder, and/or a webcam.

The user input device 1420 is configured to receive various types of data input by a user of the system 1000 and include, e.g., a touch pad, a keypad, a keyboard, a mouse, and/or a microphone.

The sensor 1430 is configured to detect various types of physical quantities, which may be obtained from the outside of the system 1000, and convert the detected physical quantities into electric signals. The sensor 1430 may include, e.g., a temperature sensor, a pressure sensor, an illuminance sensor, a position sensor, an acceleration sensor, a biosensor, and/or a gyroscope sensor.

The communication device 1440 is configured to transmit and receive signals between other devices outside the system 1000 according to various communication protocols. The communication device 1440 may include, e.g., an antenna, a transceiver, and/or a modem.

The display 1450 and the speaker 1460 are configured to serve as output devices configured to respectively output visual information and auditory information to the user of the system 1000.

The power supplying device 1470 is configured to convert power supplied from a battery (not shown) embedded in the system 1000 and/or an external power source, and supply the converted power to each of components of the system 1000.

The connecting interface 1480 is configured to provide connection between the system 1000 and an external device, which is connected to the system 1000 and capable of transmitting and receiving data to and from the system 1000. The connecting interface 1480 may be implemented by using various interface schemes, such as advanced technology attachment (ATA), serial ATA (SATA), external SATA (e-SATA), small computer small interface (SCSI), serial attached SCSI (SAS), peripheral component interconnection (PCI), PCI express (PCIe), NVMe, IEEE 1394, a universal serial bus (USB) interface, a secure digital (SD) card interface, a multi-media card (MMC) interface, an eMMC interface, a UFS interface, an embedded UFS (eUFS) interface, and a compact flash (CF) card interface.

In at least one embodiment, the storage device 11 or 100 described with reference to FIGS. 1 to 15 may be implemented with the storage devices 1300a and 1300b. Also, the processing unit 12 described with reference to FIGS. 1 to 15 may be implemented with the main processor 1100. For example, the main processor 1100 may establish a zone storage system and a RAID based on the first storage areas ZNS of the storage devices 1300a and 1300b. The main processor 1100 may write an intermediate RAID parity in the second storage area CNS of the storage devices 1300a and 1300b. The main processor 1100 may write a final RAID parity in the first storage area ZNS of the storage devices 1300a and 1300b. The description given with reference to the storage device 11 or 100 and the processing unit 12 in FIGS. 1 to 15 may be equally applied to the storage devices 1300a and 1300b and the main processor 1100 of FIG. 16.

In the above embodiments, components according to the present disclosure are described by using the terms “first”, “second”, “third”, etc. However, the terms “first”, “second”, “third”, etc. may be used to distinguish components from each other and do not limit the present disclosure. For example, the terms “first”, “second”, “third”, etc. do not involve an order or a numerical meaning of any form.

In the above embodiments, functional elements such as those including “unit”, “processor”, “controller,” “manager,” “logic”, etc., described in the specification mean elements that process at least one function or operation, and may be implemented as processing circuitry such as hardware, software, or a combination of hardware and software, unless expressly indicated otherwise. The functional elements may be implemented with various hardware devices, such as an integrated circuit, an application specific IC (ASIC), a field programmable gate array (FPGA), and a complex programmable logic device (CPLD), firmware driven in hardware devices, software such as an application, or a combination of a hardware device and software. For example, the processing circuitry more specifically may include, but is not limited to, electrical components such as at least one of transistors, resistors, capacitors, etc.,/or electronic circuits including said components, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. Also, the functional elements may include circuits implemented with semiconductor elements in an integrated circuit, or circuits enrolled as an intellectual property (IP).

According to embodiments of the present disclosure, an electronic device providing a reduced write amplification factor (WAF) with respect to a plurality of storage devices by permitting only a sequential write in a zone provided in the plurality of storage devices and an operating method of the electronic device are provided. Also, an electronic device that has an improved speed and improved reliability by generating a RAID parity by using a random access memory and storing an intermediate parity and a parity in a storage device and an operating method of the electronic device are provided.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A storage system comprising:
a random access memory;
a plurality of storage devices; and
processing circuitry configured to control the random access memory and the plurality of storage devices,
wherein each of the plurality of storage devices includes a first storage area and a second storage area,
wherein the processing circuitry is configured to
assign a zone to the first storage areas of the plurality of storage devices,
assign a plurality of Redundant Array of Inexpensive Disks (RAID) stripes to the zone,
write sequential data with respect to each of the plurality of RAID stripes, the sequential data based on sequential logical addresses,
write of a parity corresponding to the write of the sequential data after the write of the sequential data is completed, and
wherein the processing circuitry is further configured to
write an intermediate parity, corresponding to the parity, in the second storage area of at least one storage device, among the plurality of storage devices while performing the write of the sequential data.

2. The storage system of claim 1, wherein each of the plurality of RAID stripes includes
a plurality of zone areas where the sequential data is written, and
a RAID area where the parity is written,
wherein the plurality of zone areas and the RAID area respectively correspond to the plurality of storage devices.

3. The storage system of claim 2, wherein the processing circuitry is configured to
write first data in a first zone area from among zone areas of a first RAID stripe, the first zone area corresponding to a first storage device,
generate a first intermediate parity based on the first data, and
write the first intermediate parity in the random access memory and in the second storage area of a third storage device, of the plurality of storage devices, corresponding to the first RAID stripe.

4. The storage system of claim 3, wherein the processing circuitry is configured to
write second data in a second zone area from among the zone areas of the first RAID stripe, the second zone area corresponding to a second storage device,
read the first intermediate parity from the random access memory,
generate a second intermediate parity based on the first intermediate parity and the second data, and
write the second intermediate parity in the second storage area of the third storage device.

5. The storage system of claim 4, wherein the first intermediate parity is invalidated after the second intermediate parity is written.

6. The storage system of claim 4, wherein the first intermediate parity and the second intermediate parity are written in the second storage area of the second storage device and based on the same logical address.

7. The storage system of claim 4, wherein the first intermediate parity and the second intermediate parity are written in the second storage area of the second storage device based on different logical addresses.

8. The storage system of claim 3, wherein the processing circuitry is configured to
write second data in a second zone area from among the zone areas of the first RAID stripe, the second zone area corresponding to a second storage device;
read the first intermediate parity from the random access memory,
generate the parity based the first intermediate parity and the second data, and
write the parity in the RAID area of the first RAID stripe corresponding to the third storage device.

9. The storage system of claim 8, wherein, the first intermediate parity is invalidated after the parity is written in the RAID area of the first RAID stripe corresponding to the third storage device.

10. The storage system of claim 8, wherein, after a power is turned on, the processing circuitry is configured to
determine whether the parity is written in the RAID area of the first RAID stripe corresponding to the third storage device and whether the first intermediate parity is written in the second storage area of the third storage device corresponding to the RAID area of the first RAID stripe, and read the first intermediate parity from the second storage area of the third storage device corresponding to the RAID area of the first RAID stripe, in response to a determination that the parity is not written in the RAID area of the first RAID stripe corresponding to the third storage device and that the first intermediate parity is written in the second storage area of the third storage device corresponding to the RAID area of the first RAID stripe, and
store the parity in the random access memory based on the first intermediate parity.

11. The storage system of claim 8, wherein, when an error occurs in the first RAID stripe, the processing circuitry is configured to
determine whether the parity is written in the RAID area of the first RAID stripe corresponding to the third storage device and whether the first intermediate parity is written in the second storage area of the third storage device corresponding to the RAID area of the first RAID stripe, and
recover the first RAID stripe based on data written in the first RAID stripe and the first intermediate parity in response to a determination that the parity is not written in the RAID area of the first RAID stripe corresponding to the third storage device and the first intermediate parity is written in the second storage area of the third storage device corresponding to the RAID area of the first RAID stripe.

12. The storage system of claim 1, wherein the processing circuitry is further configured to
store the intermediate parity corresponding to the parity in the random access memory,
generate the parity using the intermediate parity written in the second storage area of the at least one storage device among the plurality of storage devices in response to an error occurring in the intermediate parity stored in the random access memory or a power-on event occurring after a power-off event, and
generate the parity using the intermediate parity stored in the random access memory in response the error not occurring in the intermediate parity stored in the random access memory or the power-off and the power-on event not occurring.

13. An operating method of a storage system including a plurality of storage devices each including a first storage area and a second storage area, the method comprising:
writing first data in the first storage area of a first storage device of the plurality of storage devices;
generating a first intermediate parity from the first data;
writing the first intermediate parity in the second storage area of a fourth storage device of the plurality of storage devices;
writing second data in the first storage area of a second storage device of the plurality of storage devices;
generating a second intermediate parity from the first intermediate parity and the second data; and
writing the second intermediate parity in the second storage area of the fourth storage device.

14. The method of claim 13, further comprising:
writing third data in the first storage area of a third storage device;
generating a parity from the second intermediate parity and the third data; and
writing the parity in the first storage area of the fourth storage device.

15. The method of claim 14, wherein the first data, the second data, and the third data correspond to sequential logical addresses.

16. The method of claim 14, further comprising:
invalidating the first intermediate parity of the second storage area of the fourth storage device after writing the second intermediate parity in the second storage area of the fourth storage device; and
invalidating the second intermediate parity of the second storage area of the fourth storage device after writing the parity in the first storage area of the fourth storage device.

17. The method of claim 14, further comprising:
invalidating the first intermediate parity and the second intermediate parity of the second storage area of the fourth storage device after writing the parity in the first storage area of the fourth storage device.

18. The method of claim 14, further comprising:
recovering the first data, the second data, and the second intermediate parity based on the first data, the second data, and the second intermediate parity in response to an error occurring in the first data or the second data before the parity is written in the first storage area of the fourth storage device.

19. The method of claim 14, further comprising:
recovering the first data, the second data, the third data, and the parity based on the first data, the second data, the third data, and the parity in response to an error occurring in the first data, the second data, or the third data after the parity is written in the first storage area of the fourth storage device.

20. A storage system comprising:
a random access memory;
a plurality of storage devices; and
a processing circuitry configured to control the random access memory and the plurality of storage devices,
wherein each of the plurality of storage devices includes a first storage area and a second storage area,
wherein the processing circuitry is configured to
assign a zone to the first storage areas of the plurality of storage devices,
write first data in the first storage area of a first storage device of the plurality of storage devices,
generate a first intermediate parity from the first data,
write the first intermediate parity in the random access memory and the second storage area of a fourth storage device of the plurality of storage devices,
write second data in the first storage area of a second storage device of the plurality of storage devices,
generate a second intermediate parity from the first intermediate parity and the second data,
write the second intermediate parity in the random access memory and the second storage area of the fourth storage device,
write third data in the first storage area of a third storage device,
generate a parity from the second intermediate parity and the third data, and
write the parity in the first storage area of the fourth storage device.
